(19) United States
(12) Patent Application Publication
(10) Pub. No.: US 2008/0129639 A1
(43) Pub. Date: Jun. 5, 2008

(54) Multi-Band Antenna, Circuit Board And Communication Device

(76) Inventor: Kenichi Mitsugi, Tokyo (JP)

Correspondence Address: PAUL, HASTINGS, JANOFSKY & WALKER LLP, 875 15th Street, NW, Washington, DC, 20005, US

(21) Appl. No.: 11/596,284

(22) PCT Filed: May 10, 2005
(86) PCT No.: PCT/JP05/08830

§ 371 Date: Aug. 22, 2007

(30) Foreign Application Priority Data
May 12, 2004 (JP) 2004-142558

(51) Int. Cl. H01Q 3/24; H01Q 9/04

(52) U.S. Cl. 343/876; 343/700 MS

(57) ABSTRACT

There is provided a small multi-band antenna that is capable of supporting multiple bands. A first sub-element (11) is disposed at a region where strength of electric field becomes relatively large while power is being fed on a main element (10) capable of irradiating a high-frequency signal of a plurality of frequency bands, and a second sub-element (12) is disposed at a region in which strength of electric field becomes relatively small while power is being fed on the main element (10). Then, the first and second sub-elements (11) and (12) are operated as passive reflective elements by putting one end portions of the first and second sub-elements (11) and (12) into an electrically open state by inputting a control signal of a first level to a switching mechanism (14), and are operated as electrically short-circuit elements that couple in high frequency with the main element (10) by grounding one end portions directly or via a predetermined resonance circuit by inputting the control signal of a second level. Thus, the high-frequency signal irradiated from the main element (10) is switched to any one of the plurality of frequency bands.

### TECHNOLOGICAL FIELD

The present invention relates to a portable communication device such as a portable radio telephone and PDA (Personal Digital Assistant) capable of supporting a plurality of media such as sounds, images (still and motion images), and data and to a multi-band antenna built therein.

### BACKGROUND OF THE INVENTION

Portable communication devices such as a portable radio telephone has been remarkably advanced. Such the communication devices not only have a function of speech but also increasingly tend to have multi-media characteristics including data and image communications. Even an antenna of the portable radio telephone or a mobile communication device is influenced by the tendency, which increases demand for a multi-band antenna that is small and is capable of communicating in a plurality of frequency bands.

Up to now, as a multi-band antenna of this type, there has been an antenna device described in JP11-136025A (first conventional example), an antenna device described in JP 10-209733 A (second conventional example), an antenna device described in JP 11-68456 A (third conventional example), an antenna device described in JP 2002-335117 A (fourth conventional example), and an antenna device described in JP 2003-124730 A (fifth conventional example) for example.

The antenna device described in the first conventional example has a ground electrode formed on an entire surface of one main surface of a rectangular parallelepiped base, a radiating electrode with one end being an open end on another main surface of the base and another end being a ground end (connected to the ground electrode), a feed electrode formed in close proximity to the open end of the radiating electrode through an intermediary of a first gap, one or more control electrodes formed in close proximity to the open end of the radiating electrode through an intermediary of a second gap, and a switch for connecting/disconnecting the control electrode and the ground electrode. When the antenna device is to be used, a resonance frequency of the radiating electrode is switched by changing magnitude of the entire electrostatic capacity by turning this switch on/off.

The antenna device described in the second conventional example has, beside the ground electrode, the radiating electrode, and the feed electrode described in the first conventional example, one or more auxiliary radiating electrodes formed continuously in a body with the radiating electrode and a switch for connecting/disconnecting the auxiliary radiating electrode and the ground electrode in high frequency. When the antenna device is to be used, the resonance frequency of the radiating electrode is switched by changing an inductance component of a ground part of the radiating electrode by turning on/off the switch.

The antenna device described in the third conventional example is provided with frequency switching means (semiconductor switch) on a surface of a rectangular parallelepiped base that has the ground electrode, radiating electrode, and feed electrode thereon as described in the first conventional example, and is arranged so as to switch a resonance frequency of the radiating electrode by changing the inductance component or electrostatic capacitive component by operating this frequency switching means.

In the antenna device as described in the fourth conventional example, a rectangular parallelepiped base is mounted on a packaging board having a ground conductor section, a radiating electrode with one end being an open end and the other end being a ground end and an antenna-side control electrode (corresponds to the control electrode in the first conventional example) are provided on the surface of the base, a board-side control electrode in a state of floating from the ground and resonance frequency adjusting means (solder bridge, strip and the like having at least one of the inductance component and electrostatic capacitive component) for connecting the board-side control electrode with the ground conductor section in high frequency are provided on the packaging board, and the resonance frequency of the radiating electrode can be varied by changing impedance of the resonance frequency adjusting means.

The antenna device described in the fifth conventional example has two types of antenna elements (correspond to the radiating electrode described above) with one end being an open end, one of branched other end being a ground end, another one of the branched end being a feeding end, respectively, and two types of switches for electrically connecting/disconnecting the respective antenna elements and a ground conductor section of a packaging board, and is arranged so as to switch a resonance frequency of the whole device by simultaneously turning on one switch and turning off the other switch.

For the multi-band antenna mounted in the recent mobile communication devices, one which is capable of using a plurality of bands in combination is desired such as AMPS (Advanced Mobile Phone System) (824 MHz to 894 MHz), GSM (Global System for Mobile Communications) 900 (880 MHz to 960 MHz) , GSM 1800 (1710 MHz to 1880 MHz), DCS (Digital Cellular System) (1710 MHz to 1850 MHz), PCS (Personal Communications System) 1900 (1850 MHz to 1990 MHz), and UMTS (Universal Mobile Telecommunications System) (1920 MHz to 2170 MHz).

Because the antenna devices in the first to fourth conventional examples include the surface mounting antenna as their main components, respectively, those antenna devices are extremely small and convenient in building in a portable radio telephone or a mobile communication device. However, when a number of bands increases, a band switching mechanism of such the antenna device becomes complicated. Further, because large reactance is added to the radiating electrode, again of the antenna drops. Further, narrowed band of the resonance frequency is problematic.

Although the antenna device of the fifth conventional example is capable of supporting the increase in number of bands. However, there is a problem in which the antenna device requires to assure an enough area for the antenna elements and is difficult to downsize because the antenna device has a restriction in which two types of antenna elements need to be disposed substantially on a single plane and because each antenna element has a special and complex shape.

In order to solve the above-mentioned problems, an object of the present invention is to provide a small and broadband multi-band antenna, a communication device having the multi-band antenna capable of supporting multiple bands and of avoiding a complicated switching mechanism, and a circuit board that is a part of the communication device.

### DISCLOSURE OF THE INVENTION

A multi-band antenna according to the present invention includes: a main element capable of irradiating high-frequency signals of a plurality of frequency bands; a first sub-element provided in a region which is apart from the main element and the intensity of electric field becomes relatively strong in the region while power is being fed to the main element; a second sub-element provided in a region which is apart from the main element and the intensity of electric field becomes relatively small in the region while power is being fed, by a predetermined distance from each of the main element and the first sub-element; and a switching mechanism for switching a high-frequency signal irradiated from the main element to any one of the plurality of frequency bands by changing electrical actions of the first and second sub-elements with respect to the main element.

According to the above-mentioned multi-band antenna, a plurality of resonance frequencies can be obtained by varying the resonance frequency without any change of the element structure.

The switching mechanism includes, for example, a semiconductor switch for selectively connecting one end portion of the first and the second sub-elements between multiple types of previously formed electrical circuit elements in response to a control signal inputted from the outside. Accordingly, the plurality of resonance frequencies can be switched from outside at any time.

The switching mechanism operates, for example, the first and second sub-elements as passive reflective elements with respect to the main element by putting the respective one end portions into an electrically open state when the control signal of a first level is inputted, and operates the first and second sub-elements as electrical short-circuit elements that couple in high frequency with the main element by grounding the one end portions directly or via a predetermined resonance circuit when the control signal of a second level different from the first level is inputted. Alternatively, the semiconductor switch operates the first and second sub-elements as first electrical short-circuit elements that couple in high frequency with the main element by grounding the respective one end portions via a first resonance circuit when the control signal of the first level is inputted, and operates the first and second sub-elements as second electrical short-circuit elements that couple in high frequency with the main element by grounding the one end portions via a second resonance circuit whose electrical constant is different from that of the first resonance circuit when the control signal of the second level different from the first level is inputted.

According to an embodiment mode of the present invention, the first sub-element operates as a reactance adjusting element for giving reactance of capacitive coupling to the main antenna by capacitively coupling with the main element, and the second sub-element operates as a passive inductive element for causing the main element to excite a high-frequency signal by inductively coupling with the main element. The first sub-element is formed in such a size as to cancel a value of capacitive coupling between the second sub-element and the main element.

According to a specific embodiment mode of the multi-band antenna of the present invention, electrical length of the main element is approximately nλ/8 (n=1, 2, . . . ) of a set frequency selected out of the plurality of frequency bands, and electrical length of the second sub-element is approximately (2n+1)λ/4 (n=0, 1, 2, . . . ) or approximately nλ/2 (n=1, 2, . . . ) of the set frequency. Further, the main element is a conductive thin plate having a shape of inversed L, inversed F, or rectangular, and the second sub-element is a conductive thin plate having a shape of meander or rectangular.

In view of facilitating mounting to a communication device, the multi-band antenna includes a base of size that can be attached to or built in a communication device. The base is provided with a ground conductor and an element mounting board made of a dielectric. The element packaging board includes a main element mounting layer keeping a predetermined distance from the ground conductor, a dielectric later having a predetermined thickness, and a second sub-element mounting layer being laminated in this order, the main element mounting layer is attached to the main element, and the sub-element mounting layer is mounted on the first and second sub-elements in parallel by a predetermined distance.

In view of further facilitating mounting to a communication device, in the multi-band antenna, the main element is plated or formed as a conductive pattern on one surface section of a front surface section and back surface section of the circuit board built in the communication device, and the first and second sub-elements are formed as conductive patterns in regions that receive electrical influence of the main element on another surface of the circuit board.

A circuit board of the present invention is made of a dielectric, and built in the communication device, for mounting components of the communication device, and has a function of the multi-band antenna. The circuit board further has an antenna are a electrically influenced between front and back surface sections thereof. In the circuit board, the main element is plated or formed as a conductive pattern on one surface section of the front and back surface sections of the antenna area, and the first and second sub-elements are formed as conductive patterns on another surface section of the front and back surface sections of the antenna area.

A communication device according to the present invention includes the multi-band antenna stored in a case thereof, in which the communication device is arranged so that the main antenna is made to irradiate a high-frequency signal of set frequency selected out of a plurality of frequency bands by controlling the switching mechanism provided in the multi-band antenna using a control signal.

According to the present invention, a small-size multi-band antenna that is capable of supporting multiple bands and suitably attached to or built in a communication device can be materialized. It becomes possible to considerably expand the uses of portable radio equipment and mobile radio equipment that are examples of the communication device by mounting or building such multi-band antenna thereon or therein. As a result, the portable and mobile terminals can be diversified.

### BRIEF DESCRIPTION OF THE DRAWINGS

FIG. 1 is a basic structural diagram of a multi-band antenna of the present invention.

FIG. 2 is a diagram showing a relationship among a main element, a first sub-element, and a second sub-element in a first state.

FIG. 3 is a diagram showing a relationship among the main element, the first sub-element, and the second sub-element in a first state.

FIG. 4 is a frequency-VSWR characteristic graph of the multi-band antenna in the first and second states.

FIG. 5 are diagrams showing structural examples of a trap circuit connected to the second sub-element, in which FIG. 5(a) shows an example of a parallel resonance circuit of an inductive element and a capacitive element, FIG. 5(b) shows a series resonance circuit thereof, and FIG. 5(c) shows a series-parallel resonance circuit thereof.

FIGS. 6(a) to 6(c) are explanatory drawings each showing a state where the multi-band antenna is mounted in portable radio and telephone equipments.

FIG. 7 is a diagram showing a first exemplary application of a switching mechanism.

FIG. 8 is a VSWR-frequency characteristic graph in the switching mechanism of FIG. 7.

FIG. 9 is a diagram showing a second exemplary application of the switching mechanism.

FIG. 10 is a VSWR-frequency characteristic graph in the switching mechanism of FIG. 9.

FIG. 11 is an external perspective view (main part) of a base for mounting the multi-band antenna to a communication device.

FIG. 12 is a side view of the base seen from a direction of an arrow of FIG. 11.

FIGS. 13 are drawings for explaining a structure and size of the base for mounting the antenna element, in which FIG. 13(a) is a plan view of the base and FIG. 13(b) is a side view thereof.

FIG. 14(a) is a front view of an element mounting cover 70 and FIG. 14(b) is a side view thereof.

FIG. 15(a) is a table showing a relationship between bands that can be set and set frequencies (resonance frequency) at that time and FIG. 15(b) is a table showing voltage values of a control signal CONT when a desirable band is selected.

FIG. 16 is a structural diagram of the multi-band antenna according to an embodiment of the present invention.

FIGS. 17(a) and 17(b) are VSWR-frequency characteristic graphs when the control signal is switched to 0 [V] and to 3 [V].

FIGS. 18(a) and 18(b) are gain characteristic graphs when the control signal is switched to 0 [V] and to 3 [V].

FIG. 19 (a) is a front view of an antenna area part of a circuit board having the function of the multi-band antenna, FIG. 19(b) is a back view thereof, and FIG. 19(c) is a sectional view for clarifying a relationship between front and back surface sections within the antenna area part.

### BEST MODE FOR CARRYING OUT THE INVENTION

### [Basic Structure of Antenna]

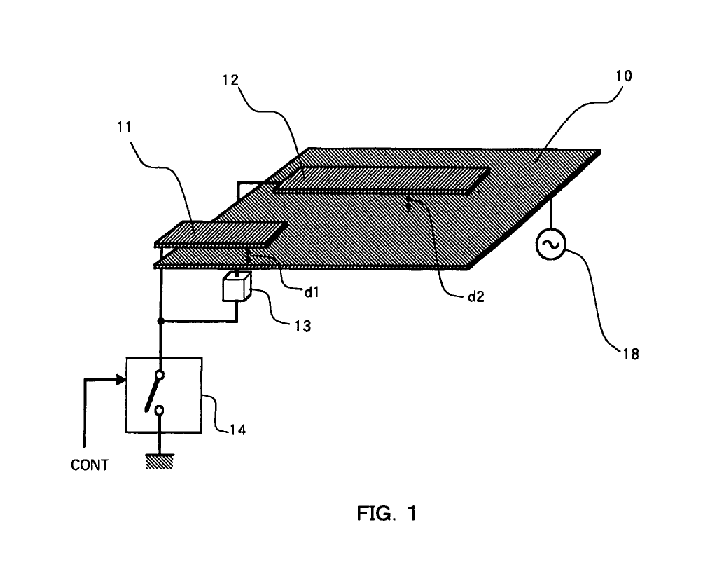

FIG. 1 shows a basic structural view of a multi-band antenna of the present invention. The multi-band antenna of the present invention may be mounted in a portable radio telephone and a mobile portable communication device such as PDA capable of supporting a plurality of media such as sound, images (still image and motion image), and data.

As shown in FIG. 1, the multi-band antenna of the present invention has a main element 10 capable of irradiating a high-frequency signal supplied from a feed terminal 18. The main element 10 is made of a conductive thin plate formed of a copper material, for example. One of front and back surface sections of the main element 10, e.g., the front surface section, is a radiating surface section capable of irradiating signals of a plurality of frequencies.

The main element 10 is provided with a first sub-element 11 near an outer peripheral end of the radiating surface section at which intensity of electric field becomes strongest while power is being fed.

A main surface section of the first sub-element 11, i.e., a surface section whose surface area is relatively large, faces the radiating surface section of the main element 10 with a predetermined distance there between d1 so the main element 10 capacitively couples with the first sub-element 11 while power is being fed. In the case of the first sub-element 11 formed in a long strip as shown in the figure, an edge portion of the first sub-element 11 is a free end on the radiating surface section of the main element 10. The other end portion of the first sub-element 11, i.e., a base end portion, extends from one end of the main element 10 and conductively connects with one end of a switching mechanism 14.

An area of the main surface section of the first sub-element 11 is determined by a magnitude of capacitive coupling to be adjusted. The larger the area is, the larger the capacitive coupling becomes. Thus, while the area of the main surface section of the first sub-element 11 is essential, its shape and length in a longitudinal direction are not so important. When it is necessary to secure a larger area of the main surface section, it may be formed in, for example, meander (zigzag) instead of the long strip as shown in the figure.

A second sub-element 12 is provided approximately at the center of the radiating surface of the main element 10, i.e., at a region where the electric field intensity becomes relatively small while power is being fed. When the main antenna 10 is formed in a long thin plate as shown in the figure, a main surface section of the second sub-element 12 and the radiating surface of the main element 10 oppose each other in parallel with a predetermined distance d2 therebetween, so the main element 10 inductively couples (magnetic field coupling) with the second sub-element 11 while power is being fed. Unlike the first sub-element 11, length of the second sub-element 12 in the longitudinal direction is important because the second sub-element 12 is coupled inductively.

An edge portion of the second sub-element 12 is a free end on the radiating surface of the main element 10. The other end of the second sub-element 12, i.e., a base end portion, extends from the end portion of the main element 10 and conductively connects with one end of a trap circuit 13. A distance between the base end portion of the first sub-element 11 and that of the second sub-element 12 is set to be a distance that can practically avoid “sneak path” of the frequency in use. Size and the like of these elements will be described later.

The other end of the trap circuit 13 is electrically connected with one end of the switching mechanism 14.

This trap circuit 13 is composed of an inductive element and a capacitive element and eases a degree of high-frequency coupling of the second sub-element 12 with the main element 10.

The other end of the switching mechanism 14 is electrically connected with an earth terminal, i.e., a terminal that becomes earth potential while power is being fed. The switching mechanism 14 carries out open/close operations based on a control signal CONT supplied from the outside. During the “open” operation, the base end portion of the first sub-element 11 and the other end of the trap circuit 13 are in an open state having no electrical connection at all, and during the “close” operation, the base end portion of the first sub-element 11 and the other end of the trap circuit 13 are put in an earth potential state. For convenience of the explanation, the open state will be referred to as a first state and the earth potential state as a second state.

It should be noted that although FIG. 1 shows the example in which the first and second sub-elements 11 and 12 are provided above the radiating surface section of the main element 10, either one or both of the first and second sub-elements 11 and 12 may be provided on the side of the back surface section of the main element 10.

### <Operation of Multi-band Antenna>

The multi-band antenna constructed as described above operates as follows.

### [First State]

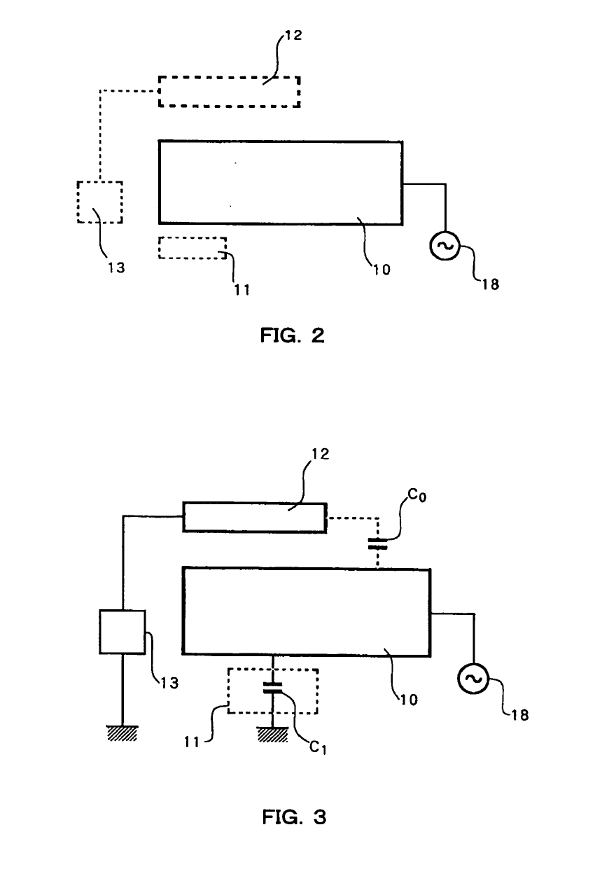

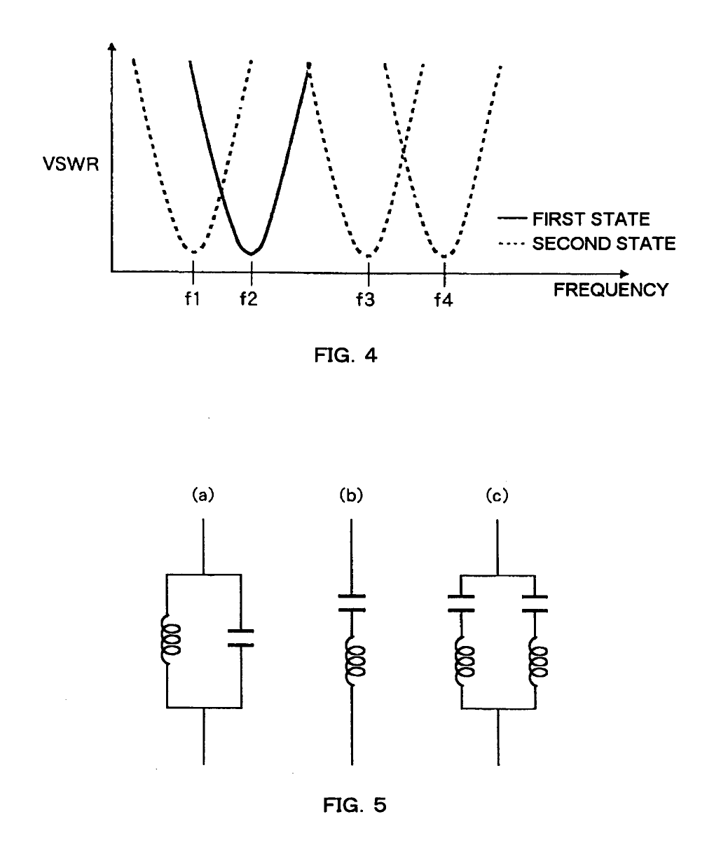

In the first state, the first and second sub-elements 11 and 12 become passive reflective elements that have almost no electrical influence on the main element 10. The trap circuit 13 also gives no influence. FIG. 2 shows this state by broken lines. At this time, the main element 10 operates as an “edge open antenna” that resonates a high-frequency signal supplied from the feed terminal 18 with a second resonance frequency f2 set to itself as shown by a solid line in a VSWR-frequency characteristic graph in FIG. 4.

### [Second State]

In the second state, both of the first and second sub-elements 11 and 12 become passive elements. Accordingly, the main element 10 operates as an “antenna attached with passive elements”. FIG. 3 shows this state by solid lines. At this time, the main element 10 capacitively couples with the first and second sub-elements 11 and 12 and is applied with reactance corresponding to the intensity of the capacitive coupling (this intensity will be referred to as a “value of capacitive coupling”. The value of capacitive coupling between the main antenna 10 and the first sub-element 11 is C₁. A capacitive coupling value C₀ is also generated between the main antenna 10 and the second sub-element 12.

Due to the influence of these capacitive coupling values C₁ and C₀, the resonance frequency of the main element 10 becomes a first resonance frequency f1 that is different from the resonance frequency (second resonance frequency f2) of the main element 10 itself.

Variation of the resonance frequency in the main element 10 depends on a value of the given reactance, and specifically, on the capacitive coupling values C₁ and C₀ given by the first and second sub-elements 11 and 12. As the value of capacitive coupling increases, the resonance frequency in the main element 10 changes to be lowered.

The capacitive coupling values C₁ and C₀ generated by the capacitive coupling of the first and second sub-elements 11 and 12 become low impedance in terms of high frequency at a certain frequency or more, and each of the first and second sub-elements 11 and 12 operates as an electrical short-circuit point of the main element 10. Therefore, the multi-band antenna also operates as an edge short-circuit antenna that resonates with a fourth resonance frequency f4.

Further, the second sub-element 12 operates as a passive inductive element and a third resonance frequency f3 of the second sub-element 12 is excited by the main element 10. At this time, it is possible to reduce the influence of the second sub-element 12 on the second resonance frequency f2 by determining the electric constant of the trap circuit 13 to substantially correspond to the frequency of the second resonance frequency f2 of the main element 10 included in the second sub-element 12.

The relationship of the first resonance frequencies f1, f3, and f4 with the second resonance frequency f2 is shown by broken lines in the VSWR-frequency characteristic graph of FIG. 4.

### [Shape, Structure, and the like of Elements]

The shape of the main element 10 may be arbitrary as long as the main element 10 has a structure capable of irradiating high-frequency signals of a plurality of frequencies. For example, the main element 10 may be formed in the shape of an inversed L, inversed F, meander, or the like which is well known as elements for the high frequency band antenna, besides being formed in the shape of the rectangular thin plate.

The main element 10 is designed so that the resonance frequency (second resonance frequency f2) falls substantially within the frequency band in use. In order to set the frequency such that it becomes the set frequency arbitrarily set within the frequency band in use, electrical length of the main element 10 is set to be about nλ/8 (n=1, 2, . . . ) when a wavelength of the frequency band in use is set as λ.

The first sub-element 11 operates as the passive reflective element in the first state and as the electrical short-circuit element and the passive element, or specifically, as a reactance-adjusting element with respect to the main element 10 in the second state. Because the first sub-element 11 operates as descried above in the second state, there is a case where the first sub-element 11 needs a relatively large capacitive coupling value C₁ in order to attain a desirable resonance frequency. Still more, the first sub-element 11 is formed in the size at which the capacitive coupling value C₀ between the second sub-element 12 and the main element 10 is cancelled.

Therefore, while the first sub-element 11 is disposed at the region where the electric field of the main element 10 is concentrated so that the electric field optimally couples, the distance d1 descried above and the area of the front surface section of the first sub-element 11 also become important. This is because the capacitive coupling value C₁ is determined from the distance d1 and the area described above.

A procedure for designing the capacitive coupling value C₁ such that the resonance frequency becomes the frequency set in the frequency band in use is as follows. First, the above-mentioned distance d1 is set based on the height of an antenna case that can be stored in a case of the communication device to be used, and a distance between the elements determined based on the required antenna performance. Next, the area of the main surface section of the first sub-element 11 is adjusted so that the necessary capacitive coupling value C₁ may be obtained.

The second sub-element 12 operates as the passive reflective element in the first state and as the passive inductive element and the electrical short-circuit element in the second state. That is, when the capacitive coupling value C₁ obtained from the capacitive coupling of the first sub-element 11 is smaller than the capacitive coupling value C₀ obtained from the capacitive coupling of the second sub-element 12, the second sub-element 12 whose capacitive coupling value C₀ becomes relatively large operates as an electrical short-circuit point of the main element 10.

This second sub-element 12 is disposed near the center of the main element 10 where concentration of the electric field of the main element 10 is small, in order to achieve reduction of the reactance given to the main element 10 (reduction of capacitive coupling) and to enable optimal inductive coupling. However, because there is a case where the reduction of the reactance given to the main element 10 (reduction of capacitive coupling) is not enough, the trap circuit 13 having a predetermined electrical constant is inserted into the second sub-element 12. It is noted that the predetermined electrical constant of the trap circuit is defined such that the high impedance is obtained at the frequency to be used. The predetermined electrical constant of the trap circuit 13 is set to correspond to approximately at the second resonance frequency f2 of the main element 10. Accordingly, in the first and second states, the trap circuit 13 has high impedance around the second resonance frequency f2 of the main element 10, and becomes the passive reflective element by the second resonance frequency f2. Accordingly, the influence of the capacitive coupling C₀ of the second sub-element 12 and the main element 10 on the second resonance frequency f2 can be reduced.

The trap circuit 13 includes an inductive element and a capacitive element as main parts, and is constructed either by a parallel resonance circuit of those elements as shown in FIG. 5(a), by a series resonance circuit as shown in FIG. 5(b), or a series-parallel resonance circuit as shown in FIG. 5(c).

Because the parallel resonance circuit as shown in FIG. 5(a) has high impedance during resonation, it is suitable for use of not passing a certain frequency. Because the series resonance circuit as shown in FIG. 5(b) has low impedance during resonation, it is suitable for use of passing only a certain frequency. The series-parallel resonance circuit as shown in FIG. 5(c) is suitable for the of not passing a certain frequency but passing other two frequencies.

A procedure for designing the second sub-element 12 so as to have a desirable structure is as follows. First, the distance d2 described above is determined from the height of the antenna case that can be stored in the case of the communication device to be used and the distance between the elements determined from required antenna performance. Next, an element width of the second sub-element 12 is set so that the optimal inductive coupling is achieved in accordance with a resonance frequency bandwidth and VSWR of the antenna excited by the main element 10. At this time, the capacitive coupling value C₀ caused by the capacitive coupling is set approximately at a value at which the influence on the first and second resonance frequencies f1 and f2 is reduced.

The resonance frequency (third resonance frequency f3) of the second sub-element 12 is set so that it falls substantially within the frequency band in use. In order to arrange the resonance frequency so that it falls substantially within the frequency band in use, the length of the second sub-element 12 is set to be approximately (2n+1)λ/4 (n=0, 1, 2, . . . ) or approximately nλ/2 (n=1, 2, . . . ).

The respective sub-elements 11 and 12 are set at the distance at which coupling with each other is not allowed and at which the sub-elements 11 and 12 give no influence to the performance. An air layer or a dielectric may be interposed between the main element 10 and the respective sub-elements 11 and 12. It is possible to obtain a large capacity with a small area by increasing a dielectric constant.

### [Description of Switching Mechanism]

The switching mechanism 14 switches in terms of conductivity the ground conductor disposed at a predetermined region of the communication device and the base end portion of the first and second sub-elements 11 and 12 by the control signal CONT inputted to a control terminal. Beside the mechanical switch, it is possible to use, depending on its use, a semiconductor switch, e.g., a widely used Shottky diode as well as a PIN diode when isolation is to be emphasized, an FET switch and an IC switch when low current operations are to be emphasized, and an MEMS switch when a strong electric field and low distortion are to be emphasized.

The mechanism can also be configured to allow selection of a plurality of routes such as SPDT (Single Pole Double Throw), SP3T (Single Pole 3 Throw), and SP4T (Single Pole 4 Throw).

### <Communication device Incorporating Multi-band Antenna>

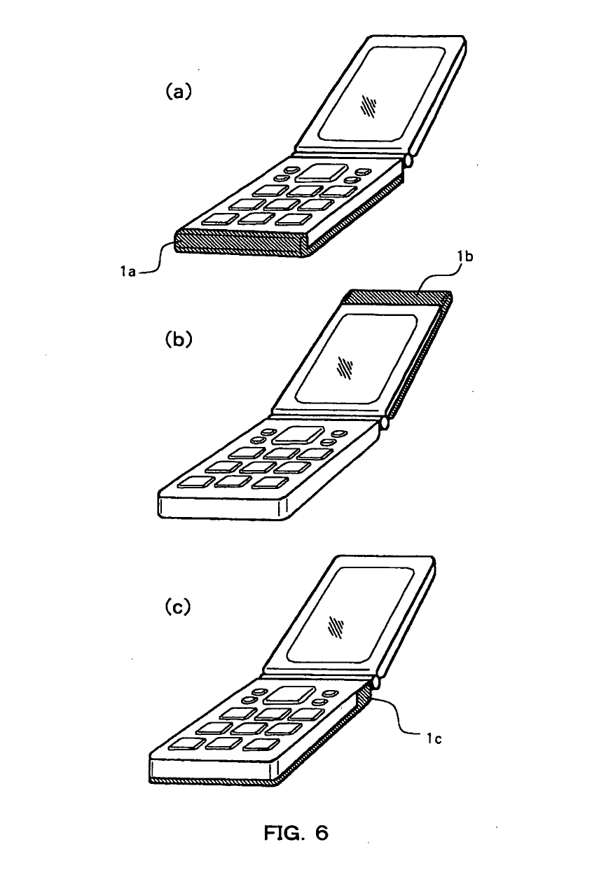

The multi-band antenna of the present invention may be mounted or built in various communication devices. When the communication device is a portable radio telephone, for example, the multi-band antenna of the present invention may be mounted at places shown in FIGS. 6(a) to 6(c). FIG. 6(a) shows an example in which the ground conductor is attached to the back surface side of a manipulating section of the portable radio telephone and in which a multi-band antenna la is attached to an end of the manipulating section. FIG. 6(b) shows an example in which the ground conductor is attached to the back surface side of a display section of the portable radio telephone and in which a multi-band antenna lb is attached to an edge portion of the display section. FIG. 6(c) shows an example in which the ground conductor is attached to the back surface side of the manipulating section and in which a multi-band antenna 1c is attached to an end of the back surface. The multi-band antenna of the present invention may be accommodated (incorporated) in the case. The communication device is provided with a control unit for switching the frequency band in use by switching a signal level of the control signal CONT described above.

It should be noted that the multi-band antenna may be appropriately replaced and used in accordance with the required performance. In this case, the communication device is provided with a mechanism for removably attaching the multi-band antenna at the regions described above. The multi-band antenna has an attachment mechanism formed therein which corresponds to the above-mentioned mechanism.

### [Exemplary Application]

While the case where the first and second sub-elements 11 and 2 (trap circuit 13) are connected to one end of the switching mechanism 14 and the earth terminal is connected to the other end, respectively, and where the multi-band antenna is put into the first state by causing the switching mechanism 14 to perform the “open” operation and the multi-band antenna is put into the second state by causing the switching mechanism 14 to perform the “close” operation has been shown in the example described above, the present invention is not limited to such the example and may form various antenna states. Exemplary applications of an electronic circuit connected to the switching mechanism 14 will be explained in the following description.

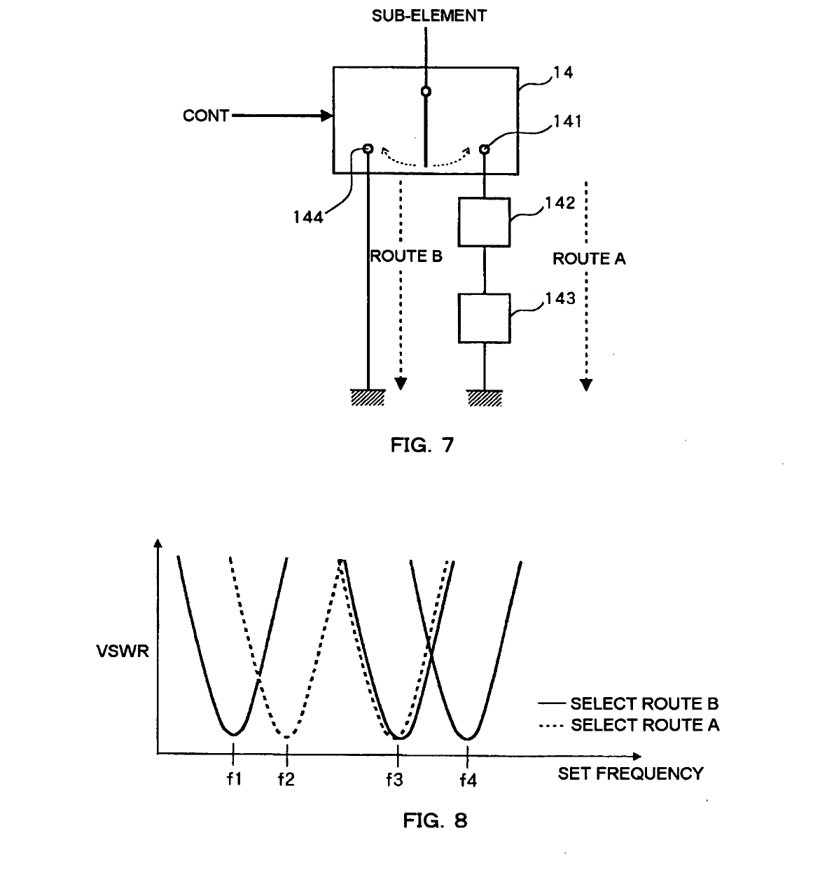

FIG. 7 shows a first exemplary application. An SPDT (Single Pole Double Throw) switching element is used, for example, as the switching mechanism 14. Then, among two selected terminals of the switching mechanism 14 connected respectively to the ground conductor, a series circuit of a reactance element (inductive element or capacitive element) 142 and a trap circuit 143 is inserted and connected to a first terminal 141, and a second terminal 144 is directly connected to the ground conductor so that these two routes may be selected by the control signal CONT.

The route from the first terminal 141 to the ground conductor via the reactance element 142 and the trap circuit 143 will be referred to as “route A”, and the route from the second terminal 144 directly to the ground conductor will be referred to as “route B”. An electric constant of the trap circuit 143 is set approximately at the second resonance frequency f2 of the main element 10 or at the third resonance frequency f3 of the second sub-element 12 so that it causes high impedance in each of the set frequency bands. Accordingly, it becomes possible to reduce the influence in the respective frequency bands in selecting the route.

When the switching mechanism 14 selects the route B by the control signal CONT, the same effect can be obtained as in the case of the second state described above. That is, the main element 10 capacitively couples with the first sub-element 11 and the first sub-element 11 gives reactance (value of capacitive coupling) to the main element 10. Therefore, the second resonance frequency f2 of the main element 10 changes to the first resonance frequency f1. At the same time, the main element 10 is electrically short-circuited via a coupling point by the capacitive coupling and resonates with the fourth resonance frequency f4 that sets this short-circuit point as peripheral length.

Further, the second sub-element 12 operates as the passive inductive element and the third resonance frequency f3 of the second sub-element 12 is excited by the main element 10. Solid lines in a VSWR-frequency characteristic graph of FIG. 8 show a relationship between the resonance frequency and VSWR in this state.

On the other hand, when the switching mechanism 14 selects the route A by the control signal CONT, the trap circuit 143 becomes high impedance at the second resonance frequency f2 of the main element 10 and the respective sub-elements 11 and 12 become passive reflective elements at the second resonance frequency f2. Therefore, the influence of the sub-elements 11 and 12 on the second resonance frequency f2 becomes small and the main element 10 operates with the second resonance frequency f2. Still more, the second sub-element 12 operates as the passive inductive element and the third resonance frequency f3 of the second sub-element 12 is excited by the main element 10.

Broken lines in the VSWR-frequency characteristic graph of FIG. 8 shows a relationship between the resonance frequency and VSWR in this state. As described above, it is possible to change the setting of selection of each resonance frequency, and to vary each resonance frequency by inserting the reactance element, thereby performing fine setting.

### [Other Exemplary Application]

FIG. 9 shows a second exemplary application. Here, the series circuit of the reactance element (inductive element or capacitive element) 145 and the trap circuit 146 that is the same as those in the first exemplary application is inserted and connected also to the second terminal 144 in the first exemplary application.

A route from the first terminal 141 to the ground conductor via the reactance element 142 and the trap circuit 143 will be referred to as “route C (the same with the route A) and a route from the second terminal 144 to the ground conductor via the reactance element 145 and the trap circuit 146 will be referred to as “route D”. The electric constant of the trap circuit 143 is set approximately at the third resonance frequency f3 of the second sub-element 12. Further, the electric constant of the trap circuit 146 is set approximately at the second resonance frequency f2 of the main element 10. It is possible to reduce the influence in the respective frequency bands in selecting the route by causing high impedance in the respective set frequency bands.

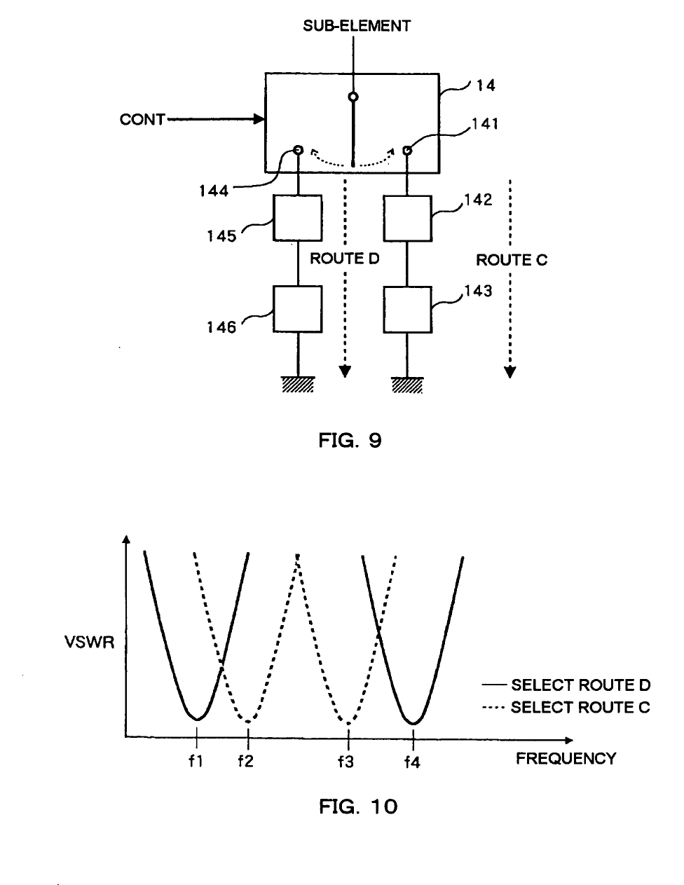

When the switching mechanism 14 selects the route D by the control signal CONT, the main element 10 is capacitively coupled with the first sub-element 11, and the first sub-element 11 gives reactance to the main element 10. Therefore, the second resonance frequency f2 of the main element 10 changes to be the first resonance frequency f1. At this time, high impedance is caused approximately in the third resonance frequency f3 by the trap circuit 143, and the respective sub-elements 11 and 12 become passive reflective elements at the third resonance frequency f3. Accordingly, the third resonance frequency f3 is not excited by the main element 10. At the same time, the main element 10 is electrically short-circuited via the coupling point by the capacitive coupling, and resonates with the fourth resonance frequency f4 that sets this short-circuited point as its peripheral length. Solid lines in a VSWR-frequency characteristic graph of FIG. 10 show a relationship between the resonance frequency and the VSWR in this state.

On the other hand, when the switching mechanism 14 selects the route C by the control signal CONT, the trap circuit 146 causes high impedance approximately in the second resonance frequency f2 of the main element 10, and the respective sub-elements 11 and 12 become passive reflective elements at the second resonance frequency f2. The influence of the respective sub-elements 11 and 12 on the second resonance frequency f2 becomes small and the main element 10 operates with the second resonance frequency f2. Still more, the second sub-element 12 operates as the passive inductive element and the third resonance frequency f3 of the second sub-element 12 is excited by the main element 10.

Broken lines in the VSWR-frequency characteristic graph of FIG. 10 show a relationship between the resonance frequency and the VSWR in this state.

Thus, it is possible to change the setting of selection of each resonance frequency, and to vary each resonance frequency by inserting the reactance element, thereby performing fine setting.

### EMBODIMENT 1

Next, an embodiment of the multi-band antenna of the present invention will be explained specifically.

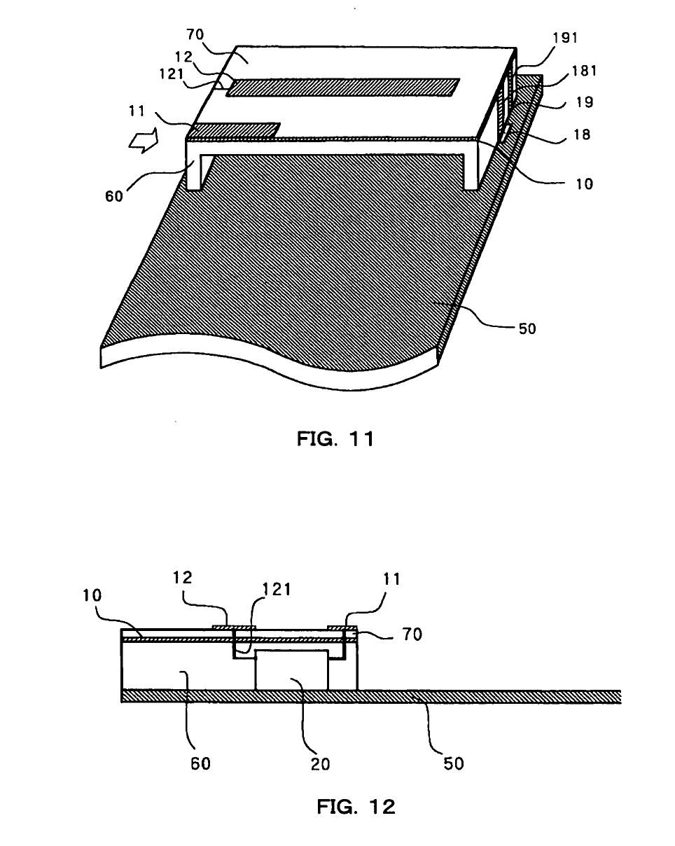

Here, a multi-band antenna downsized so as to be suitably incorporated into the communication device will be exemplified. FIG. 11 is a external perspective view (main part) of a base for mounting the multi-band antenna to the communication device and FIG. 12 is a side view of the base seen from a direction of arrow of FIG. 11. In those figures, components considered to be same or understood to be same with those already described will be denoted by the same reference numerals for convenience.

The multi-band antenna of this embodiment is constructed by mounting the main element 10 having a shape of inversed F, for example, on a dielectric board such as a base 60 made of epoxy glass (FR-4) provided on an edge portion of the ground conductor 50 to which the earth terminal of the switching mechanism 14 is connected. Then, an element mounting cover 70 made of epoxy glass (FR-4) having a predetermined thickness is laminated on the main element 10 and the first and second sub-elements 11 and 12 are mounted on the element mounting cover 70. The base end portion of the first sub-element 11 is directly connected to a peripheral circuit 20 and the second sub-element 12 is connected to the peripheral circuit 20 through a wire 121. The main element 10 is connected to the feed terminal 18 via a feed line 181 and a predetermined region thereof is connected to the ground terminal 19 via an earth line 191. It should be noted that when a rectangular thin plate is used as the main element 10, there is no need to be grounded.

The peripheral circuit 20 is a circuit in which the trap circuit 13 (143, 146) and the switching mechanism 14 described above are mounted in combination. The control signal CONT for selectively switching the first and second states, the routes A and B and the routes C and D described above is inputted to the peripheral circuit 20 from a control circuit of the communication device. When the switching element composing the switching mechanism 14 is a PIN diode, the control signal CONT is a voltage of 0 to 3 [V] for example. The control signal CONT switches the respective states and routes described above by changing the voltage between 0 [V] (OFF) and 3 [V] (ON) when power consumption is 3.0 [mA]. As a result, the plurality of frequency bands can be switched.

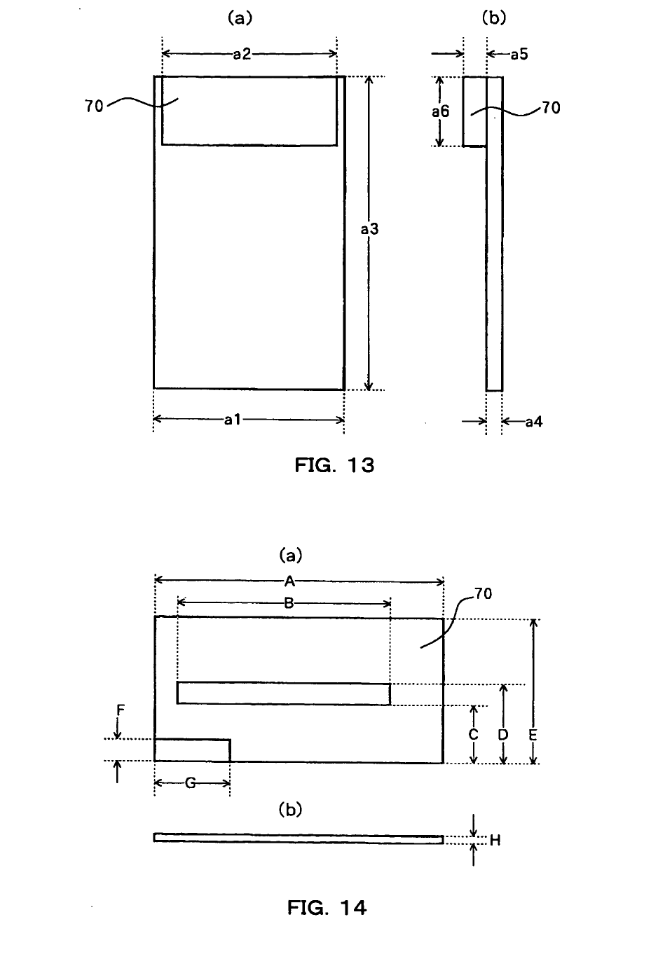

Next, a size of the mounting board in mounting the multi-band antenna of the present invention will be exemplified. FIGS. 13 are drawings for explaining the structure and size of the packaging board, in which FIG. 13(a) is a plan view of the packaging board and FIG. 13(b) is a side view thereof. FIG. 14(a) is a front view of the element mounting cover 70 and FIG. 14(b) is a side view thereof.

In FIG. 13, a width al of the ground conductor is 40 mm for example, height a3 is 100 mm for example, and a thickness a4 is 1.0 [mm] for example. A width a2 of the mounting board mounted on the ground conductor is 38 [mm] for example, height a6 is 18 [mm] for example, and a thickness a5 is 7.0 [mm] for example.

In FIG. 14(a), a width A of the element mounting cover 70 is a2 described above and height E is a6 described above. In FIG. 14(b), a thickness H, i.e., the size corresponding to the distances d1 and d2 described above, is 0.5 [mm] for example. It should be noted that this thickness H may not always be constant and may vary in accordance with the regions for mounting the respective sub-elements 11 and 12.

Length G of the first sub-element 11 on the element mounting cover is 3.0 [mm] for example, length B of the second sub-element 12 is 30.0 [mm] for example, length C from one end of the main element 10 to one end of the second sub-element 12 is 8.0 [mm] for example, and length D from the one end of the main element 10 to another end of the second sub-element 12 is 12.0 [mm] for example.

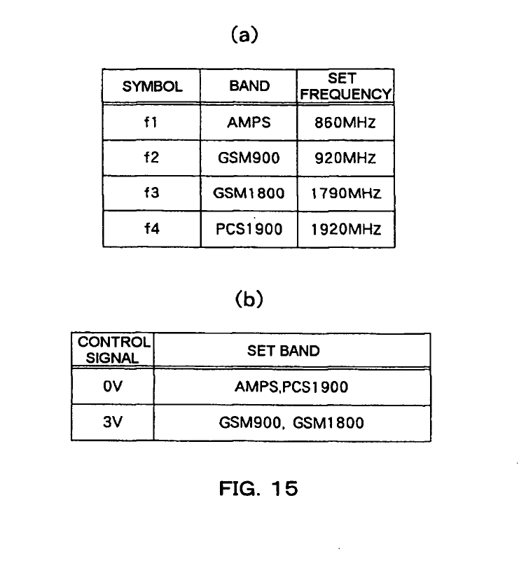

FIG. 15(a) shows bands that can be set in this embodiment and set frequencies (resonance frequencies) at that time.

That is, the first resonance frequency f1 described above is in the band of AMPS (824 MHz to 894 MHz), the second resonance frequency f2 described above is in the band of GSM 900 (880 MHz to 960 MHz), the third resonance frequency f3 described above is in the band of GSM 1800 (1710 MHz to 1880 MHz), and the fourth resonance frequency f4 described above is in the band of PCS 1900 (1850 MHz to 1990 MHz).

FIG. 15(b) shows the voltage value of the control signal CONT in selecting a desirable band. That is, when the AMPS band or the PCS 1900 band is used in the structure as shown in FIG. 9 for example, the control signal CONT is set at 0 [V] so that the radiating surface section of the main element 10 irradiates the high-frequency signal of the first and fourth resonance frequencies f1 and f4 as shown in FIG. 10. When the GSM 900) band or the GSM 1800 band is used on the other hand, the control signal CONT is set at 3 [V] so that the radiating surface section of the main element 10 irradiates the high-frequency signal of the second or third resonance frequencies f2 or f3.

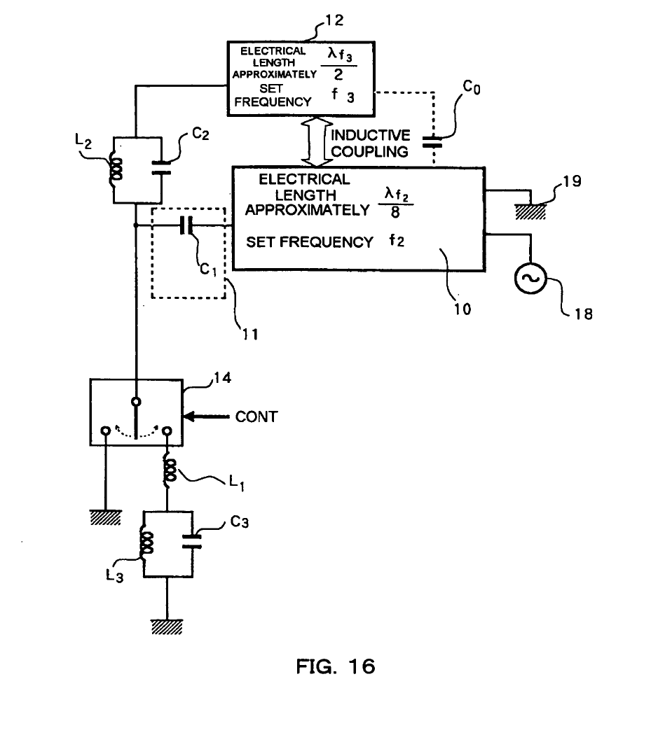

FIG. 16 is a structural view of the embodiment of the antenna according to the present invention.

The main element 10 in this embodiment is a thin plate element made of copper having a shape of inversed F and is connected between the feed terminal 18 and the ground terminal 19. The resonance frequency (set frequency) set for the main element 10 is f2 and electrical length is approximately λ_{f2}/8 when wavelength of the set frequency is λ_{f2}. The resonance frequency (set frequency) set for the second sub-element 12 is f3 and electrical length is approximately λf3/2 when wavelength of the set frequency is λ_{f3}. The capacitive coupling value C₀ generated by the capacitive coupling between the second sub-element 12 and the main element 10 is 3.5 [pF]. The trap circuit connected to the second sub-element 12 is a parallel circuit of an inductive element L₂ and a capacitive element C₂,and reactance of the inductive element L₂ is 15 [nH] and reactance of the capacitive element C₁ is 2 [pF]. The capacitive coupling value C₁ given to the main element 10 by the first sub-element 11 is 2.5 [pF].

As the switching mechanism 14, one shown in FIG. 7 is adopted. That is, a SPDT semiconductor IC switch is used as the switching element, an inductive element L₁ is used as the reactance element for adjusting resonance frequency, and a parallel circuit of an inductive element L₃ and a capacitive element C₃ is used as the trap circuit. Reactance of the inductive element L₃ is 1.5 [nH], reactance of the inductive element L₃ is 15 [nH] , and reactance of the capacitive element C₃ is 2 [pF].

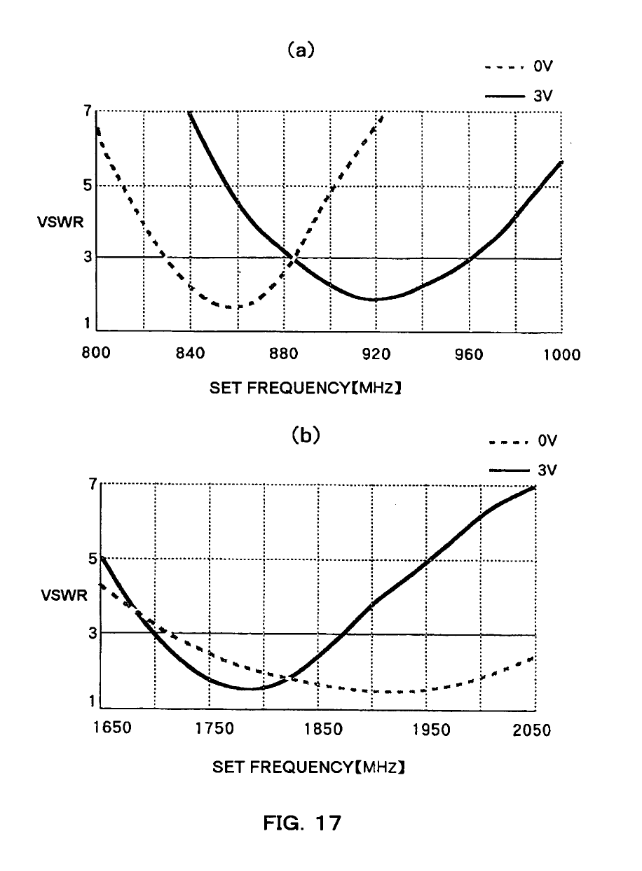

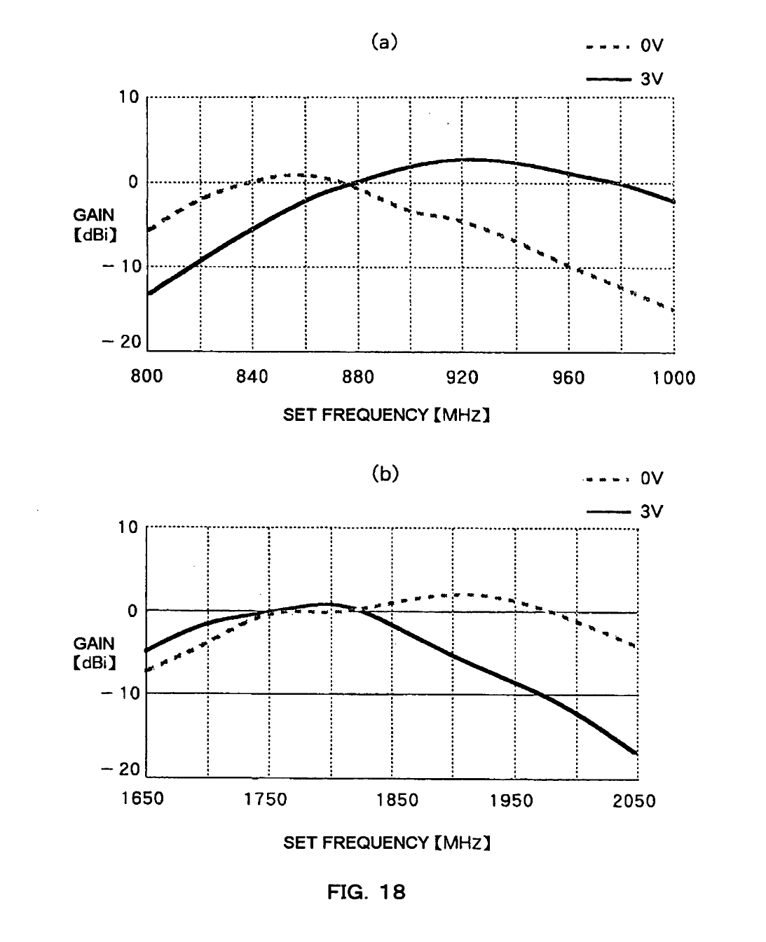

In the multi-band antenna constructed as described above, the VSWR-frequency characteristic when the control signal is switched to 0 [V] and 3 [V] is as shown in FIGS. 17(a) and 17(b). FIG. 17(a) shows the VSWR-frequency characteristics in the AMPS band and the GSM 1900 band, and FIG. 17(b) shows the VSMR-frequency characteristics in the GSM 900 band and the GSM 1800 band. FIGS. 18 show gain characteristics when the control signal is switched to 0 [V] and 3 [V] . FIG. 18(a) shows the gain characteristics in the AMP band and the GSM 1900 band, and FIG. 18(b) shows the gain characteristics in the GSM 900 band and the GSM 1800 band.

As described above, according to the embodiment mode and the specific embodiment of the present invention, it is possible to operate the first sub-element 11 as the passive reflective element, the reactance adjusting element, and the electrical short-circuit element and to operate the second sub-element 12 as the passive inductive element, the passive reflective element, or the electrical short-circuit element capable of resonating with a frequency different from that of the main element 10, so that the multi-band antenna that can have more resonance frequencies without increasing the number of elements, is capable of supporting the broadband, and is also small, may be readily realized.

It should be noted that the shapes, the numerical values representing the sizes, the disposition, and the like of the respective elements shown in the embodiment mode and the embodiment described above are illustrative and it is needless to say that the scope of the present invention is not limited to thereto.

### EMBODIMENT 2

Next, another embodiment of the present invention will be explained. While the example described above is an example in which the multi-band antenna is implemented mainly as an antenna part incorporated in the communication device and the like, the multi-band antenna may be implemented as conductive plating and a conductive pattern directly formed on a circuit board composing the communication device and the like.

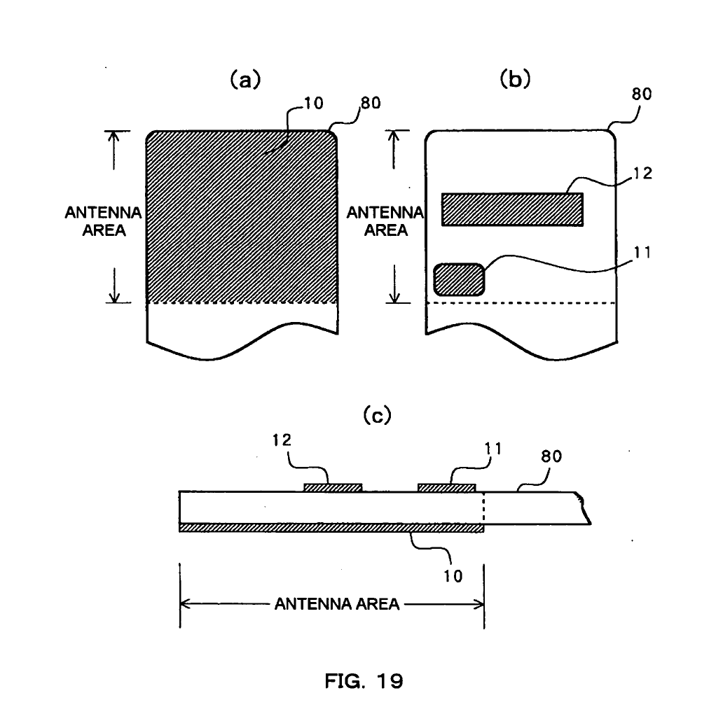

That is, as shown in FIG. 19(a), a front surface section of an antenna area of a circuit board 80 is plated by the conductive plate for example to set the plated part as the main element 10 and an approximately rectangular conductive pattern is formed near an end portion of a back surface section of the antenna area of the circuit board 80 and a lengthy thin plate conductive pattern is formed approximately near the center thereof, respectively, by etching as shown in FIG. 19(b) so that the former functions as the first sub-element 11 and the latter as the second sub-element 12.

FIG. 19(c) is a sectional view for clarifying the relationship of the front surface and the back surface of the antenna area part of the circuit board 80. The “antenna area” is an area in which there is no metal layer between the front surface and the back surface in the circuit board 80 made of a dielectric. In case of this embodiment, a thickness of the circuit board 80 becomes the distances d1 and d2 described above. The conductive plate and the conductive patterns thus formed on the circuit board 80 may have the same relationship with the basic structure of FIG. 1 and have the same effect with the embodiment described above. The trap circuit 13 and the switching mechanism 14 shown in FIG. 1 may be mounted at regions other than the antenna area of the circuit board 80.

The thickness of the circuit board 80 may be set almost as high as the multi-band antenna in this embodiment. Therefore, there arises a merit in which the communication device may be thinned as compared to the case of providing the mounting base 60 and the element mounting cover 70.

It should be noted that in case of a circuit board that is formed of a multilayer board, a part of those layers is a metal layer, and the front surface is shielded from the back surface, the metal layer may be cut out to form an antenna area or an antenna are a maybe added separately. Alternatively, in case of a multilayer board whose metal layer is partial even though the metal layer exists and which will give no big influence to the relationship of coupling between the main element 10 and the first and second sub-elements 11 and 12 by forming the main element 10 in a shape of the inversed F or inversed L for example, the multilayer board may be used as the antenna area as it is.

1. A multi-band antenna, comprising:
a main element capable of irradiating high-frequency signals of a plurality of frequency bands;
a first sub-element provided in a region above the main element in which intensity of electric field becomes relatively strong while power is being fed, by a predetermined distance from the main element;
a second sub-element provided in a region above the main element in which intensity of electric field becomes relatively small while power is being fed, by a predetermined distance from each of the main element and the first sub-element; and
a switching mechanism for switching a high-frequency signal irradiated from the main element to any one of the plurality of frequency bands by changing electrical actions of the first and second sub-elements with respect to the main element.

2. A multi-band antenna according to claim 1, wherein the switching mechanism includes a semiconductor switch for switching between one end portions of the first and second sub-elements to connect the one end portions with multiple types of electrical circuit elements formed in advance in response to a control signal inputted from the outside.

3. A multi-band antenna according to claim 2, wherein the switching mechanism operates the first and second sub-elements as passive reflective elements with respect to the main element by putting the respective one end portions into an electrically open state when the control signal of a first level is inputted, and operates the first and second sub-elements as electrical short-circuit elements that couple in high frequency with the main element by grounding the one end portions directly or via a predetermined resonance circuit when the control signal of a second level different from the first level is inputted.

4. A multi-band antenna according to claim 2, wherein the semiconductor switch operates the first and second sub-elements as first electrical short-circuit elements that couple in high frequency with the main element by grounding the respective one end portions via a first resonance circuit when the control signal of the first level is inputted, and operates the first and second sub-elements as second electrical short-circuit elements that couple in high frequency with the main element by grounding the one end portions via a second resonance circuit whose electrical constant is different from that of the first resonance circuit when the control signal of the second level different from the first level is inputted.

5. A multi-band antenna according to claim 3, wherein:
the first sub-element operates as a reactance adjusting element for giving reactance of capacitive coupling to the main antenna by capacitively coupling with the main element; and
the second sub-element operates as a passive inductive element for causing the main element to excite a high-frequency signal by inductively coupling with the main element.

6. A multi-band antenna according to claim 5, wherein the first sub-element is formed in such a size as to cancel a value of capacitive coupling between the second sub-element and the main element.

7. A multi-band antenna according to claim 6, wherein:
electrical length of the main element is approximately nλ/8 (n=1, 2, . . . ) of a set frequency selected out of the plurality of frequency bands; and
electrical length of the second sub-element is approximately (2n+1)λ/4 (n=0, 1, 2, . . . ) or approximately nλ/2 (n=1, 2, . . . ) of the set frequency.

8. A multi-band antenna according to claim 7, wherein:
the main element (10) is a conductive thin plate having a shape of inversed L, inversed F, or rectangular; and
the second sub-element is a conductive thin plate having a shape of meander or rectangular.

9. A multi-band antenna according to claim 8, comprising a base of size that can be attached to or built in a communication device, wherein:
the base is provided with a ground conductor and an element mounting board made of a dielectric;
the element packaging board includes a main element mounting layer keeping a predetermined distance from the ground conductor, a dielectric later having a predetermined thickness, and a second sub-element mounting layer being laminated in this order;
the main element mounting layer is attached to the main element; and
the sub-element mounting layer is mounted on the first and second sub-elements in parallel by a predetermined distance.

10. A multi-band antenna according to claim 8, wherein:
the main element is plated or formed as a conductive pattern on one surface section of a front surface section and back surface section of the circuit board built in the communication device; and
the first and second sub-elements are formed as conductive patterns in regions that receive electrical influence of the main element on another surface of the circuit board.

11. A circuit board, which is made of a dielectric and built in the communication device, for mounting components of the communication device, and which has a function of the multi-band antenna, wherein:
the circuit board has an antenna area electrically influenced between front and back surface sections thereof;
the main element according to claim 10 is plated or formed as a conductive pattern on one surface section of the front and back surface sections of the antenna area; and
the first and second sub-elements according to claim 10 are formed as conductive patterns on another surface section of the front and back surface sections of the antenna area.

12. A communication device, comprising the multi-band antenna according to claim 1 stored in a case thereof,
wherein the communication device is arranged so that the main antenna is made to irradiate a high-frequency signal of set frequency selected out of a plurality of frequency bands by controlling the switching mechanism provided in the multi-band antenna using a control signal.
